(19) United States
(12) Patent Application Publication
(10) Pub. No.: US 2017/0020785 A1
(43) Pub. Date: Jan. 26, 2017

(54) Medical Administration and Information System

(71) Applicant: Kristin Leigh McCullough, Hillsborough, CA (US)

(72) Inventor: Kristin Leigh McCullough, Hillsborough, CA (US)

(21) Appl. No.: 15/165,805

(22) Filed: May 26, 2016

Related U.S. Application Data
(60) Provisional application No. 62/166,303, filed on May 26, 2015.

(51) Int. Cl. A61J 7/04; G06F 19/00; A61J 7/02; A61J 1/03; A61J 7/00

(52) U.S. Cl. CPC A61J 7/04; A61J 1/03; A61J 7/0076; A61J 7/02; A61J 7/0069; G06F 19/3456; G06F 19/3462; A61J 2205/30; A61J 2205/70; A61J 2205/50; A61J 2200/30; A61J 2205/60

(57) ABSTRACT

A System for storing pills in their original pharmaceutical bottles, verifying authenticity and pill count of each medication, tracking inventory, ordering refills, dispensing pills at prescribed times, providing alerts to caregivers, and reporting adherence patterns to medical providers, institutions, companies and interested parties through its Analytics system. The System accomplishes functions while displaying informational content on its touch-screen display, while showing advertisements, health recommendations, information on drug interactions, side effects, and related content on the System Device's touch-screen.

### CROSS-REFERENCE TO RELATED APPLICATIONS

This application claims priority to U.S. Provisional Application No. 62/166,303 filed May 26, 2015. The content of the above application is incorporated by reference in its entirety.

### FIELD OF THE DISCLOSURE

The disclosure relates to the field of automated medication dispensing, alert and information systems.

### BACKGROUND

This invention relates to an innovative System for verifying, dispensing and displaying scheduled medications while collecting and processing data about patient adherence.

A large portion of patients in nursing homes reside there because they are unable to manage their own prescription medications. According to the National Center for Biotechnology Information, an estimated 25% of all long-term care patients reside in their facilities solely due to failed pill management. In January, 2015, the American Medical Association estimated that 52% of all patients fail to take their medications. With consequential costs like return hospital visits, this failure rate ultimately costs the health care industry an estimated $300 billion annually.

Self-administration of different medications on different schedules can be difficult. Noticing and evaluating drug interactions can also be challenging for many patients.

The medical device industry has produced some lone-standing devices with complex pre-fill dispensing trays. These devices are difficult to load, and just as difficult to manage on schedule. If, for example, a patient needs to take medication A 3 times per day for 2 weeks, medication B 2 times per day for 10 weeks, and medication C 1 time per day for 5 weeks, and medication D “as needed” for 12 weeks, one can imagine the pre-filling and administration nightmare. Without automated loading and sorting, auto-prompted alerts and automated pill dispensation, electronic pill-dispensation devices can cause as many problems as they solve.

Other devices give notifications to caregivers and contact pharmacies, but these devices still require the patient to manually pre-sort and manage their own prescriptions, and they fail to collect and report on adherence data. Other devices require the user to pour medications into separate magazines within a device, again forcing the user to determine where pills belong and to manage their own schedule. In short, no single System or device allows a patient to simply load her pill bottles into a device and forget the rest, thereafter simply following a “dispense” prompt when her pills are ready.

What is needed is a System that stores pills in their original bottles in a substantially air-tight compartment, verifies the quantity and authenticity of individual pills within the System, tracks and updates Inventory, dispenses medication at scheduled times, provides alerts when medications are not taken, orders refills from pharmacies, and processes and reports on adherence to medical providers and institutions. Heretofore, no single device or System lets the patient leave pills in their original bottles, stores the bottles in a virtually air-tight compartment to prevent pill degradation, verifies the quantity and authenticity of brand-name medications, and also gathers meta-data on patient adherence for use in clinical trials and for sale to medical industry providers. The Pill Butler System elegantly accomplishes these tasks, and also offers a venue for pharmaceutical industry advertisers to inform patients about specific notifications and related conditions.

### BRIEF DESCRIPTION OF THE DRAWINGS

The drawings described herein are for illustrative purposes only and illustrate only selected embodiments of the present invention. The enclosed drawings are not intended to limit the scope of the present disclosure.

FIG. 1 is a front view of the exterior of the Pill Butler device in one embodiment of the present invention.

FIG. 2 is a front view of the internal components of the Pill Butler device in one embodiment of the present invention.

FIG. 3 is an aerial view of a segmented dispensing and counting tray in one embodiment of the present invention.

FIG. 4 is a block flow diagram illustrating the initial steps of the Pill Butler System in one embodiment of the present invention.

FIG. 5 is a block flow diagram illustrating the pill-dispensing and notification steps in one embodiment of the present invention.

### DEFINITIONS

Pill Butler System (“System”): The Pill Butler medication administration and information process and methods, including the Pill Butler device and associated methods, processes, administrative methods, components, tools and networks that collectively comprise the Pill Butler Medical Administration and Information System. The System comprises the Pill Butler Device, attached or remote devices, as well as the medical administration staff and System's associated software, as well as the information technologies and networks that collectively comprise the Pill Butler Medical Administration and Information System.

Device: the primary physical apparatus of the Pill Butler System, comprising, inter alia, the touch screen display, carousel pad, carousel mechanism, lid, handle, tray(s), scanner(s), processor, camera(s), processor, robotic arm, picker attachment, grabber attachment, universal gripper vacuum balloon attachment, speaker, tray table, factory floor area and dispensing area.

Cloud computing software application (“software application”): The Pill Butler's interactive, Internet-connected client-server software computing program, capable of all computing operations and functions performed by the System, and also linked to the Pill Butler's Cloud Analytics Server. The software application is able to perform, inter alia, messaging, data processing and other functions that desktop and networked software applications perform. For purposes of the present invention, web portal functions are comprised within the term “software application.” The software application may produce web portal displays, or “web pages,” on the touchscreen display. The software application is also capable of performing data processing, including optical character recognition “OCR” functions on scanned label data provided by the System's camera(s).

Touchscreen Display (“display”): as well as serving as the System's monitor, it is the front-end user interface between the user and the software application. This feature of the device is not to be confused with the Pill Butler's Display System, which is but one of the Pill Butler's subsystems, along with Inventory, Analytics, Alerting, and Display. One example of the Display system is the Advertisement Portals subsystem described below.

Identifying information: For purposes of this invention, a user's identifying information, or identifiers, are, inter alia, her name, age, phone number, and email address if available.

Lid: the top of the device which may be opened or alternatively removed. The lid locks, and may be opened via mechanical key, RFID tag, numerical code, or password via touchscreen display keypad.

Dosage schedule information: a user's medication consumption schedule, comprising the number of pills to take per day, time of day to take pills, PRN (pro re nata, or “take as needed”), whether to take with food, duration of the prescription until treatment is complete, and other consumption information.

Robotic arm “arm,”: robotic arm capable of three-dimensional motion, comprising a grabber which functions via vacuum or other mechanical means to pick up and drop bottles and pills. The arm may also comprise a picker attachment, grabber attachment, universal gripper vacuum balloon attachment, or other “hand” type attachments as needed.

Analytics: The data and meta-data, or “big data,” about patients' adherence to their prescription schedules, as well as other useful information gleaned from a patient's pill consumption pattern, locations, providers, pharmacies, medication classes, quantity intake, and other similar information. The Pill Butler System collects, records, processes and transmits these Analytics via the Pill Butler Cloud Analytics Server Database, which may be accessed by sponsors, medical providers, drug companies, research institutions and other interested bodies.

### DETAILED DESCRIPTION

In the Summary above and in this Detailed Description, and the claims below, and in the accompanying drawings, reference is made to particular features (including method steps) of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

The term “comprises” and grammatical equivalents thereof are used herein to mean that other components, ingredients, steps, among others, are optionally present. For example, an article “comprising” (or “which comprises”) components A, B and C can consist of (i.e., contain only) components A, B and C, or can contain not only components A, B, and C but also contain one or more other components.

Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number) (a second number),” this means a range whose limit is the second number. For example, 25 to 100 mm means a range whose lower limit is 25 mm and upper limit is 100 mm.

Aspects of the disclosed invention may be embodied as a system, method or process, or computer program product. Accordingly, aspects of the disclosed invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the disclosed invention may take the form of a computer program product embodied in one or more computer readable media having computer readable program code embodied thereon.

Any element in a claim that does not explicitly state “means for” performing a specified function, or “step for” performing a specific function is not to be interpreted as a “means” of “step” clause as specified in 35. U.S.C. §112 ¶6. Specifically, the use of “step of” in the claims herein is not intended to invoke the provisions of U.S.C. §112 ¶6.

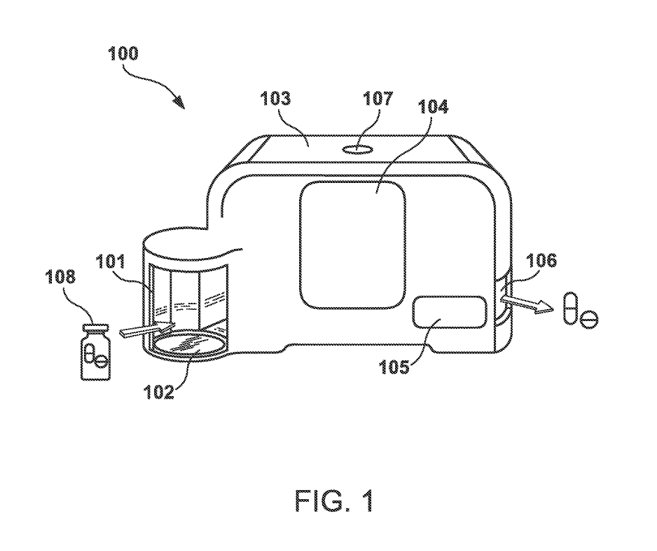

Referring to FIG. 1, the Pill Butler Device 100 comprises a door 101, which is opened and closed to allow the user to enter and retrieve pill bottles; a carousel pad 102 onto which the user places and removes pill bottles; a sealing lid 103 which, when closed, keeps the internal compartments of the Device substantially air-tight (preventing degradation of pills in the internal compartments of the Device 100); a lid handle 107, which may be magnetized to facilitate sealing and open/closing of the lid; a touchscreen display 104 which may show alerts, notifications, messages and advertisements and other web portal content comprising co-branding, sponsorship, medical journal articles, medical studies, and search engine results relating to a given medication; the touchscreen display 104 also provides keyboard functionality for the user and caregiver to enter information and commands and to communicate with the Device 100 and the System.

The Device 100 further comprises a dispense button 105 which may serve to confirm a user or caregiver's desire for the Device 100 to dispense pills when ready; the dispense button 105 may comprise a LED light to further alert the user of caregiver of its location and status.

The Device 100 further comprises a dispense area 106, positioned at one side of the Device 100. The dispense area 106 may comprise a lip shaped receptacle wherein pills may remain accessible for the user or caregiver to easily retrieve the pills. In an alternative embodiment, the dispense area 106 may comprise a chute that ejects pills to a separate, or removable cup or receptacle below.

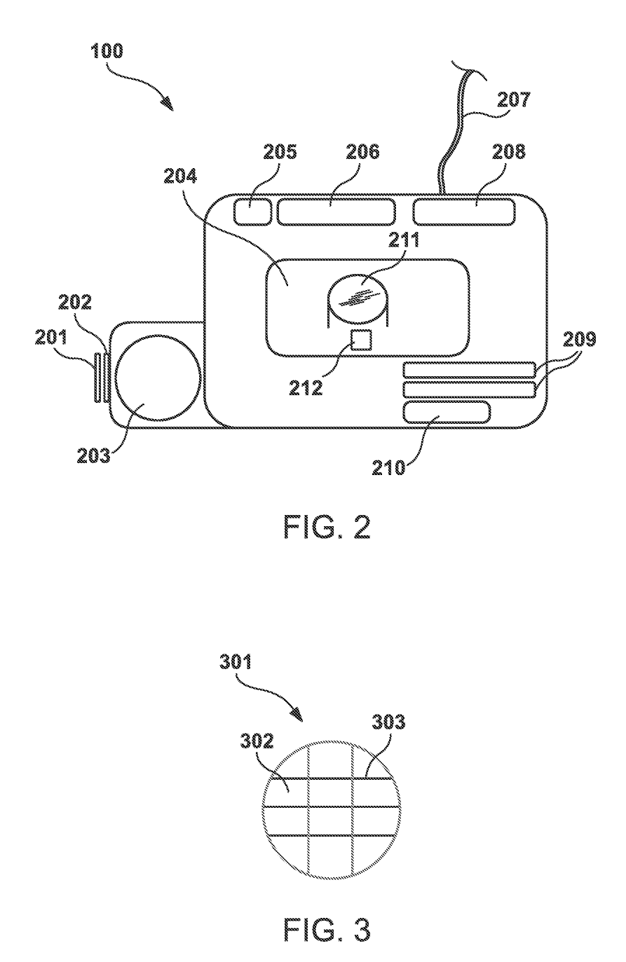

Referring to FIG. 2, the internal area of the Pill Butler Device 100 comprises an external scanner 201, which is designed to read the bar code and label information of medications whose shape or size makes them ineligible to fit into onto the carousel pad 102 or into the device's 100 internal storage system, which may comprise “shelves” on the “second floor” above the factory floor area, around the internal perimeter of the device; an internal scanner 202 which reads prescription bottles' label information, which may comprise a bar code; a carousel mechanism 203 which rotates to move the pill bottle(s) from the door area and scanning area to the factory floor area 204, where the arm further moves the bottle(s); a factory floor 204 area wherein pill counting, verification, preparation and other System functions occur; a USB Port 205 which allows the Device 100 to connect to and communicate with other devices and elements of the Pill Butler System; a Robotic Arm (“arm”) 206 capable of three-dimensional motion, comprising an optional detachable grabber hand attachment, an optional detachable picker hand attachment, an optional universal gripper vacuum balloon attachment, or other means to move pill bottles and pills; a power cord 207 and a power supply 208, which may comprise batteries and may comprise a battery compartment; pill trays 209, which may be segmented dispensing trays or may be counting trays; a processor 210 to accomplish the System's computing and data processing functions and to run the device's 100 software application; the processor 210 may be attached to or comprise a communication module and an antenna; a tray table 211 for holding pill tray(s) while pills are being counted and identified for veracity or otherwise evaluated and moved; at least one camera 212 connected to the processor 210, for viewing and analyzing the number and authenticity of pills and other related functions.

In several embodiments of the device, for liquid medications and for foil-pack medications and for other medications that do not easily fit within the primary Pill Butler device, the System also comprises a satellite device, attachable to the main device via USB cable or other means, which comprises a series of four pads with LED lights and load sensors. Medications are placed on these pads, and the pads' LED lights illuminate upon placement, removal, or alert of medications onto/off of the pads. The pads may be loaded by rack-type magazine storage area, or other loaders. The sensors may alternatively be laser or optical circuit detectors common electrical circuits, or other means.

Referring to FIG. 3, one embodiment of the pill tray 301 is a segmented dispensing tray 301. Pills are placed into and removed from individual segments 302, which are defined by segment walls 303. In some embodiments, the tray's 301 outer-edge walls 303 are about 0.5″ high while the inner segment 302 walls 303 are about 0.25″ high. In other embodiments, the trays 301 have no segments 302; in other embodiments, the trays 301 have no walls 303.

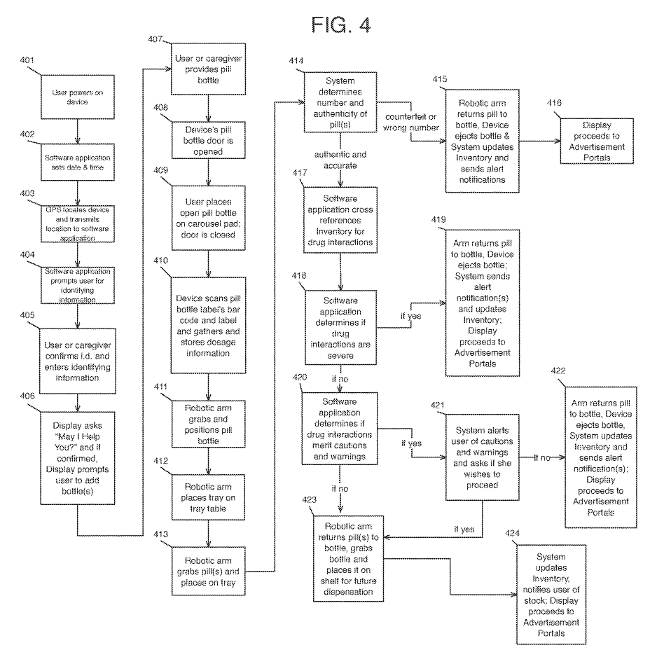

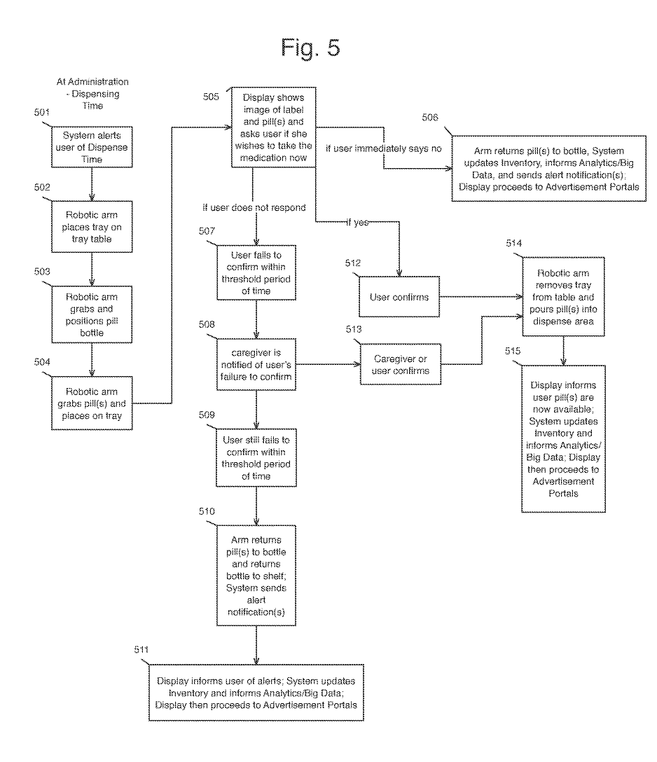

FIG. 4 is a block diagram illustrating the System startup process in one embodiment of the invention. In one embodiment; the user powers on 401 the device 100. The software application then sets 402 the device's 100 date and time. The device 100's GPS locator then locates 403 the device 100 and transmits the data to the Device 100's processor 210 and to the software application. The software application then prompts 404 the user or caregiver for identifying information. The user or caregiver then confirms her identity and enters her identifying information using the touchscreen display 104. This identifying information may include, inter alia, her name, age, address phone number, internet address if available. Note that, for power outages lasting more than 30 minutes, the System sends text, phone or email alerts to the user and to caregiver(s).

The System then prompts the user to begin 406 the loading process, displaying a “May I Help You” type of greeting. (In several embodiments, this “Wakeup-Welcome” type Prompt always remains visible on the touchscreen display 104 while the Pill Butler Device 100 is dormant). Upon user's initial confirmation via the touchscreen display 104, the touchscreen display 104 then prompts the user to add 406 a pill bottle.

In several embodiments, the touchscreen display 104 also prompts the user to add a medication to the system that is not in pill-bottle form or which is misshapen or inappropriately-sized for the internal compartments of the device 100, such as a liquid medications, foil pack medications, or other forms of medication that do not fit into the device's 100 door 101 or onto the carousel pad 102. In these circumstances, the user places the in pharmacy-generated label adjacent to the device's 100 outside scanner 201 for the device 100 to scan and enter the medication into the System. If the scanner does not work, one may input prescription and other relevant information into the System via the touchscreen display's keypad. In an alternative embodiment of the invention, the Pill Butler System comprises an optional label-generating component which creates scannable pill bottle labels that pharmacies can recognize and use. In another alternative embodiment, the user may provide her own empty bottles, or Pill Butler prefabricated bottles, for the system to sort, store and process.

After the user provides the pill bottle 407, the device's 100 door 101 is opened 408 and the user places 409 the bottle on the carousel pad 102 and the door is closed 409. The device's 100 internal scanner 202 then scans 410 the pill bottle bar code and label to gather and store dosage information into the software application. This step comprises optical character recognition functionality to utilize label information in the System.

Once scanned and entered into the software application, the arm 411 grabs and positions the bottle onto the factory floor 204 area of the device 100. The arm 206 then grabs at least one tray 209 and places 412 it on the tray table 211 in the factory floor 204 area, The arm 206 then grabs at least one pill and places 413 it on the tray 209. In some embodiments, Step 413 is accomplished when the arm 206 attaches to a mechanical grabber hand and places 413 it on the tray 209. In some embodiments, the whole bottle is emptied onto the tray for a full pill count before the pills are returned to their bottle.

The System then determines 414 the number and authenticity of the pill(s). Step 414 therefore comprises an initial Inventory count to verify that the number of pills in the bottle is the same as that listed on its label. This function is accomplished via the System's camera(s) 212 and the software application, as well as an optional load sensor.

Step 414 also comprises verification that the pills are authentic. The System accomplishes this function by taking an image of the pill(s) and processing it to obtain a set of characteristic features of the pill. These features comprise color, shape, size, scoring and surface markings. These features are then compared with a current model image gleaned from the Internet, in an alternative embodiment, the pills' features are compared with a model image previously stored in the software application. If the application makes the determination that the pill(s) are authentic, the pill bottle is accepted and the process continues to step 417. If the pills are determined to be counterfeit or are different from those listed on the label or are the wrong number, the rejection process begins via steps 415-416.

If the System determines that the pills are counterfeit or that the bottle possesses the wrong number of pills, the arm 206 returns 415 the pill(s) to the bottle, the device 100 ejects 415 the bottle and the System updates 415 Inventory and sends 415 alert notifications. The Display then proceeds 416 to Advertisement Portals.

In one embodiment, the System accomplishes steps 417 through 422 by checking the Internet for lesser drug interaction information and ejecting the bottle if the user approves.

If the System determines 418 that the drug interactions are not severe, the software application then determines 420 if the drug interactions merit cautions and warnings. If cautions and warnings are merited, the System alerts 421 the user of these cautions and warnings on the Display and asks 421 if she wishes to proceed with the medication. If the user indicates that she does not wish to proceed with the medication via the touchscreen display 104, then the arm 206 returns 422 the pill(s) to their bottle, the device 100 ejects 422 the bottle, the System updates 422 inventory and sends 422. alert notification(s), and Display proceeds 422 to Advertisement Portals. In alternative embodiments of the invention, the System further accomplishes step 420 by checking the Internet for additional drug interaction information.

If the System determines 420 that cautions and warnings are not merited, the arm 206 returns 423 pill(s) to their bottle, the arm 206 then grabs 423 the bottle and places 423 it on the device's 100 internal shelf for future dispensation. The System then updates 424 Inventory, informs Analytics, and Display proceeds 424 to Advertisement Portals.

At any point in the System, including periods when the device 100 is dormant and periods between or during steps, the user may open the device's 100 lid 103 using the handle 107 to retrieve a pill bottle or individual pill(s), such as to take a “To-Go” sampling of pills for a. vacation. The lid may be locked, accessible by passcode, key, RFID tag, or password which the user may enter via the touchscreen display's keypad. Upon being interrupted, a System step will pause for the user to re-close and re-seal the lid 103, and the System will then reset accordingly, jumping to the now-appropriate step, including updating and recalculating Inventory of all medications in the device, as well as updating Display and Analytics Systems accordingly. This process is the “manual override” functionality of the Pill Butler System. In several embodiments of the invention, whenever the device 100's lid is closed, the System performs a global inventory of all medications in the device. This feature is intended to track, and further inform and alert or report on, users who break their prescription dosage schedule and open the device to retrieve pills off schedule. These patterns are all comprised within the Analytics reporting and delivery functions in the final steps of the System.

FIG. 5 is a block diagram illustrating the System's Dispensation Process in one embodiment of the invention. in one embodiment, at dispensation time, the System alerts 501 the user of dispensation time and medication. The arm 206 then places 502 the dispensing tray 209 on the tray table 211. The arm 206 then grabs and positions 503 the appropriate pill bottle. The arm 206 then grabs 504 the appropriate pill(s) and places 504 them on the dispensing tray 209. In alternative embodiments of the invention, the arm 206 shakes the appropriate bottle at a threshold angle until the correct number of pills spills out onto the tray 209.

The touchscreen display 104 then displays the name of the pill and an image of the individual pill being dispensed and asks 505 if the user wishes to take the medication now. If the user immediately indicates via dispense button that she does not wish to take the pills now, the arm 206 returns 506 the pill(s) to their bottle, the System updates 506 Inventory (in this case with no depletion of stock), the System informs 506 Analytics of user's decision, the System sends 506 appropriate alert notification(s), and Display proceeds 506 to Advertisement Portals.

If the user fails 507 to respond to within a threshold period of time, the caregiver is notified 508 of user's failure to confirm. If the user does not respond 509 to step 508 within a threshold period of time, the arm 206 returns 510 the pills to their bottle, returns 510 the bottle to the shelf. The System then updates 511 Inventory and informs 511 Analytics. The Display then proceeds 511 to Advertisement Portals.

If the user responds to the first dispensation notification 505 by confirming 512 she wishes to take her medication now, she may do so by pressing the Dispense Button 105, which may comprise an LED light. The arm 206 then removes 514 the dispensing tray 209 from the table 211 and pours 514 the pill(s) into the dispensing area 106. The Display 104 may then further inform 515 the user that her pills are now available via the touch screen display, optionally showing an arrow to the dispense area. The System updates 515 Inventory and informs and processes Analytics. The System's Display 104 then proceeds 515 to Advertisement Portals.

At all stages of the System's processes, if the software application determines that the number of pills in any bottle is below a threshold number, the System orders refills by sending an email message to the appropriate pharmacy, or doctor and insurance company if applicable. In one embodiment of the invention, this threshold number is one week's supply of the medication. The threshold number may change in alternative embodiments. In some embodiments of the invention, the System will concurrently prompt the user by touchscreen display 104 or by email or phone, whether the user or caregiver wants to call the pharmacy or doctor for refills or inquire further. The refill subsystem is optional in all embodiments of the Pill Butler System, and can be over-ridden favoring manual refill calls. In all embodiments of the Pill Butler System, refills and refill requests are logged and processed into Inventory and Analytics.

At any point or step in the System, a user may view Inventor of all medications in the device. Inventory includes, inter alia, pills available, doses available, days remaining with/without stock, plan to restock, next Inventory update schedule, and alerts for all the above data. Dosage information comprises dosage schedule, as well as special directions (e.g. “take with food”), and other special requirements.

The Advertisement Portals are images and text information, including Internet web pages, shown on the touchscreen display 104 in a logical series. Information, images and web pages which are relevant to the user and to which Pill Butler corporate sponsors may pay to display are shown in logical order. One embodiment shows, during and after dispensation, a series of images beginning with the name and image of a particular pill concurrent with its generic name. The next Display pages, or portals, will then comprise a brief description of the medication's function, bodily or schematic images of the condition, and condensed written cautions and warnings about the medication. The next series of pages will comprise condition-related suggestions and advertising pages. These advertising pages may include media articles and videos about the medication or the underlying medical condition, new medical journal articles or videos about the medication or underlying condition, and a variety of advertising pages relating to the medication or the underlying condition.

One embodiment of the Advertisement Portals proceeds as follows: when a user is taking an anti-coagulant medication such as Coumadin, the touchscreen display 104 will show the word “Coumadin,” then an Internet-retrieved image of a brand-name Coumadin then show the generic name “Warfarin,” and then give useful information about Coumadin's capacity thin blood and to decrease blood clots, then display Internet-retrieved images of the lungs and veins of a patient with severe blood clots. The next or concurrent pages will give Coumadin's drug-interaction information, cautioning the user to avoid medications that contain NSAID, for example.

The touchscreen display 104 will then subsequently or concurrently show advertising web pages indicating treatment methods and suggestions, such as web pages for fibrous anti-coagulant foods such as whole grains and vegetables, and then show blood-thinning activities such as walking and tennis. Subsequent or concurrent web pages may include new medical journal articles about Coumadin or blood clots as well as display paid-sites such as www.clotcare.com or Drug.com.

While the System's steps are occurring, the System's software application is tracking and compiling its, and its user's, behavior for Analytics, or “big data.” Software from multiple Internet-connected Pill Butler Systems compiles and transmits individual and aggregate Analytics to the Pill Butler Cloud Analytics Server Database. The Pill Butler Cloud Analytics Server Database may be accessed by sponsors, medical providers, pharmacies, drug companies, research institutions and other parties interested in the data. The Analytics system is capable of processing and generating Reports on numbers and types of pills taken time taken, users and doctors, adherence times and tardiness patterns, total aggregate pills taken by time of day, day of week, month and year.

For legal and ethical reasons the recorded/processed aggregate Analytics data does not comprise individuals users' names, addresses, nor individual doctors' names or addresses. Analytics compiled include, inter alia, the user's home town, county, state, age, medications taken, adherence pattern, type (specialty) of doctor, doctors' location, insurance carrier, and pharmacy name and location, as well as correlations between these elements.

The Pill Butler's software compiles Analytics on user's adherence patterns, relating to steps 506 and 511. Data is collected and processed regarding late adherence, adherence failures, and the relation of particular classes of medication with these shortcomings. These Analytics show medical providers which drugs and drug combinations tend to cause non-adherence, and may inspire medical providers to inquire about the reasons for the failures (e.g. nausea, fatigue, etc). Pharmacies, drug companies and doctors can then use this data to search for anti-emetics or other ameliorative solutions.

In other cases, aggregate Analytics will show trends about medication effectiveness as it relates to dosage-time. For example, some antibiotics are as much as 50% less effective if taken 15 minutes late, while other antibiotics will prove to retain their effectiveness irrespective of late-adherence time. The Pill Butler software application also compiles Analytics on generic vs. brand-name medications' effectiveness and attractiveness (adherence) to users. Pill Butler software also compiles meta-data Analytics about geographic locations and certain medical conditions. Pill Butler software will also compile Analytics on diagnosed conditions and doctor specialties.

These Analytics are compiled by the network of Pill Butler devices within the global Pill Butler System and may be sold to medical providers or donated to research institutions.

1. An automated System for verifying and administering prescription medications to users while while tracking users' adherence patterns and providing users medical information, comprising:
a user with a name, age, email and phone number;
a prescription medication bottle containing at least one pill;
a medical prescription with a dosage schedule comprising at least one scheduled dose comprising at least one pill;
a label on the bottle indicating the prescription and its dosage schedule and other relevant information;
a pharmacy that receives refill requests;
a caregiver possessing a phone capable of receiving text messages;
a doctor;
a Cloud-source Analytics database system;
a pill dispensing device comprising:
a touchscreen display comprising a keypad feature;
an LED-lit dispense button;
a pill preparation area;
a pill dispensing area;
a lockable lid, which keeps the internal compartments of the device substantially air-tight;
an alert mechanism which informs the user of scheduled dosage times;
a label scanning mechanism;
a bottle sorting and storing mechanism;
a pill transference mechanism;
a pill verification mechanism;
a pill counting mechanism;
an inventory tracking system which periodically recalculates the pill count and dosage count of all medications in the device;
a global positioning system;
at least one camera capable of capturing images of pills in the device;
a computer processor;
at least one speaker capable of transmitting audible alerts;
an Internet-connected software application capable of sending email and text messages and accessing web-pages which the device may show on its touchscreen display;
wherein:
the user powers on the device;
the user provides their name, age, email and phone number;
the user loads a pill bottle into the device;
the label scanning mechanism gleans a dosage schedule from the label;
the pill verification mechanism determines the accuracy and authenticity of the pills in the bottle;
the pill counting mechanism determines the number of pills in the bottle and that the number matches the number indicated on the label;
the inventory tracking system enters the current pill count;
the device ejects the pill bottle if the pill count or the pill bottle contents do not match those indicated on the pill bottle's label;
the Internet-connected software application checks for severe drug interactions and ejects the pill bottle if such interactions are found; and
wherein, at the user's scheduled dosage time:
the device transfers the user's scheduled dosage of pills from the pill bottle to the pill preparation area;
the alert system notifies the user that their medication is available;
the touchscreen displays the name and image of the medication to be dispensed;
the dispense button illuminates to alert the user;
the device waits a threshold period of time for the user to press the dispense button;
after said threshold period of time, if the dispense button is still not pressed, the device sends an alert to the caregiver;
after another threshold period of time, if the dispense button is still not pressed, the device returns the dosage of pills to their pill bottle, updates inventory, and the touchscreen display proceeds to show web pages related to the user's prescription.
when the dispense button is pressed, the device transfers the dosage of pills to the dispensing area, the System updates inventory, and the touchscreen display proceeds to show web pages related to the user's prescription; and
the inventory system checks if any pill bottle has fallen below one week's dosage of the user's scheduled pills, and if so, the Internet-connected software application sends the pharmacy a refill request.

2. The System of claim 1, wherein bottle and pill transference is accomplished by a robotic arm.

3. The System of claim 1, wherein bottle and tray movement is accomplished by a robotic arm with a detachable grabber hand attachment.

4. The System of claim 1, wherein pill transference is accomplished by an iRobot™ type universal gripper balloon vacuum attachment.

5. The System of claim 1, wherein pill transference is accomplished by a robotic arm with a standard picker attachment.

6. The System of claim 1, further comprising a vacuum mechanism to clean the pill preparation Area.

7. The System of claim 1, wherein the LED-lit dispense button alert is accompanied by an audible alert transmitted by the device's speaker.

8. The System of claim 1, wherein text information on the touchscreen display is further communicated to the user via vocal commands transmitted by the device's speaker.

9. The System of claim 1, wherein the pill preparation area comprises a segmented dispensing tray.

10. The System of claim 1, wherein the device lid's sealing triggers a global inventory count upon closure.

11. The System of claim 1, wherein the device's lid remains locked and is only accessible by using a mechanical key, RFID tag or numerical key code, or password via touchscreen display.

12. The System of claim 1, wherein the Cloud-source Analytics database system compiles data on users' adherence to their prescription schedules and related adherence data such as numbers of pills taken, times taken, users' geographic to medications correlations, tardiness patterns, aggregate pills taken per times of day, month, week, and year, and related meta-data.

13. The System of claim 1, wherein the touchscreen display's web pages comprise paid advertisements.

14. The System of claim 1, wherein the touchscreen displays a series of web pages about the medication's potential drug interactions.

15. The System of claim 1, wherein the touchscreen displays a series of web pages about the user's underlying condition, including images of the condition's symptoms.

16. The System of claim 1, wherein the touchscreen displays a series of web pages about healthy foods and activities that may minimize side effects and symptoms.

17. The System of claim 1, wherein the user may override the label scanning mechanism by manually inputting a pill bottle's label information into the System via the touchscreen display's keypad.

18. The System of claim 1, wherein the System's pill verification mechanism captures and processes an image of a pill, comprising its color, shape, size and surface markings, and then compares the pill to images of authentic pills gleaned from the Internet to determine authenticity.

19. The System of claim 1, further comprising a satellite device, connected via USB, comprising illuminating LED sensor pads with load sensors for foil pack and liquid medications and other medications that do not easily work within the main device.
